(19) United States
(12) Patent Application Publication
(10) Pub. No.: US 2005/0128494 A1
(43) Pub. Date: Jun. 16, 2005

(54) Electrophotographic method and printing system for generation of a printed image

(75) Inventor: Benno Petschik, Markt Schwaben (DE)

Correspondence Address: SCHIFF HARDIN, LLP;PATENT DEPARTMENT, 6600 SEARS TOWER, CHICAGO, IL, 60606-6473, US

(73) Assignee: Oce Printing Systems GmbH, 85586 Poing (DE)

(21) Appl. No.: 10/507,560

(22) PCT Filed: Mar. 12, 2003
(86) PCT No.: PCT/EP03/02566

(30) Foreign Application Priority Data
Mar. 15, 2002 (DE) 102 11 530.3

(51) Int. Cl. G06F 15/00

(52) U.S. Cl. 358/1.8; 358/1.4; 358/1.2

(57) ABSTRACT

A method and printing system are provided for generation of a printed image, as is a data processing system for the conversion of printing data and a computer program for carrying out the method. On generation of a printed image, at least two adjacent raster blocks of image elements are illuminated with a light source. The surfaces of the raster blocks are charged dependent on the amount of incident light. On illuminating each raster surface, a portion of the light is also incident on the adjacent raster blocks. The photoconducting layer is charged in proportion to the total amount of incident light. The region colored with toner on the subsequent development of the photoconducting layer may be varied almost infinitely by varying the amount of incident light on the first and/or second raster surface, whereupon the line width of printed images is almost infinitely adjustable.

### BACKGROUND

The invention concerns an electrophotographic method to generate a print image, in that a line of a print image to be generated contains image elements that are associated with matrix-shaped raster cells. Via a light quantity emitted with the aid of a light source, the charge of a raster surface (associated with the respective image element) of a light-sensitive photoconductor layer is changed corresponding to data associated with each image element. Furthermore, the invention concerns an electrophotographic print system and a computer program to generate a print image as well as a data processing system for conversion of print data.

Presently, common electrophotographic printing systems generate print images with a resolution of 240 dpi, 300 dpi, 400 dpi and 600 dpi. The measuring unit dpi (dots per inch) specifies the number of points that can be shown on a length of 2.54 carrier material (corresponding to 1 inch). Due to increasing requirements for the print quality, the proportion of printing systems with a resolution of 600 dpi increases steadily. In order to print out on a 600 dpi printing system documents and printer's copies that have been created for output on a printing system with 240 dpi or 400 dpi, the existing print data must be further processed such that print data are generated for output on a printing system with a resolution of 600 dpi. From the International Patent Publication No. WO 98/43207-A1, a method is known in order to convert a 240 dpi print data stream as well as a 400-dpi print data stream into a 600 dpi print data stream.

In known electrophotographic printing systems, in order to generate the print image, a latent charge image is generated on a light-sensitive photoconductor material with a predetermined separation of light sources strung in series, for example, light emitting diodes (LEDs). The resolution of the printing system is permanently predetermined by the separation of the light sources strung in series and is, for example, 600 dpi in presently typical printers.

Given printing of a source image with a resolution of, for example, 240 dpi or 400 dpi on a 600 dpi printing system, target image data with a resolution of 600 dpi must be generated from the source image data. The image contents of the source image such as horizontal lines, vertical lines, and slanted lines as well as circles or similar elements should optimally be shown unaltered in the target image.

When the resolution of the target image is a whole-number multiple of the resolution of the source image (given a whole-number conversion factor), a simple conversion of the source image data into target image data is possible. The source image data are multiplied and used as target image data. For example, given a doubling of the resolution, the source image data of a source image element are assigned to four target image elements that correspond to the identical area of the source image element.

Given non-whole-number ratios such as the previously discussed 240 dpi to 600 dpi print data and of 400 dpi to 600 dpi print data, the generation of the target image data from the source image data is significantly more complicated.

From German Patent Document No. DE 691 20 962 T2, a method to generate a print image with the aid of an electrophotographic printer is known. In this method, a latent charge image is generated on a photoconductor with the aid of a laser beam. For this, respectively a predetermined light quantity is supplied to a raster surface with the aid of the laser beam, whereby a light quantity is also supplied to regions on the photoconductor bordering this raster surface since the incident area of the laser beam is greater than the raster area to be illuminated with the laser light.

From U.S. Pat. No. 5,134,495, it is known that the exposure at a specific point is dependent on the sum of the light that is radiated on this point by a plurality of light sources overlapping one another. This principle is used in order to generate additional image points outside of an image point raster physically predetermined by a print. The resolution of a print image generated with this printer can thereby be increased.

From U.S. Pat. No. 5,767,982, a method for edge smoothing is known in which the light that also falls on an adjacent raster cell upon exposure of a raster cell is used to generate a relatively even edge of the significantly round image point, whereby an edge smoothing ensues at the edge of a raster cell to be inked.

From the previously mentioned International Patent Publication No. WO 98/43207, a method is known as to how a conversion of source image data into target image data can be implement given a non whole-number transfer factor. However, in the method known from this document, the adaptation possibilities of the resolution conversion are limited to the properties of the printing system used as well as to adaptation possibilities of the print image. A line with a width of one image element given a source image resolution of 400 dpi corresponds to a line width of 1.5 image elements in a target image with 600 dpi.

However, with known printing methods, a line with a width of 1.5 image elements cannot be shown. In the conversion of the image data, in the method known from International Patent Publication No. WO 98/43207 a line is generated whose width comprises two image elements of the target image, whereby one image element is continuously activated and the second image element is alternately activated. The viewer of the target image thereby perceives the same inked area that he would perceive upon consideration of the source image. However, the contour sharpness of such a line is not satisfactory for all application cases.

In known electrophotographic printing systems, it is furthermore desirable to be able to influence the line width of lines to be shown. Above all else, in high-capacity printing systems with a print capacity of greater than 100 pages of A4 paper size per minute, perpendicular lines of the output print image have a different width than horizontal lines, although the width of both lines respectively comprises two pixels.

### SUMMARY

It is the object of the invention to provide an electrophotographic method and a printing system to generate a print image in which the line width of the used printing system can be controlled. Furthermore, a computer program to implement the method and a data processing system to convert print data is also provided.

This object is achieved by a method to generate a print image, comprising: associating image elements of a line of a print image to be generated with matrix-shaped raster cells; establishing a width of the line utilizing at least one first image element and a second image element of adjoining raster cells; changing a charge of a raster surface of a conductive layer associated with the respective image element based on corresponding data associated with each image element; providing a charge modification, corresponding to a charge distribution curve, in at least sub-regions of adjacent raster cells abutting the raster surface; supplying a first charge quantity to a first raster surface associated with the first image element, the first charge quantity discharging the first raster surface below a development threshold or charging the first raster surface such that the charge of the first raster surface is above the development threshold; supplying a second charge quantity smaller relative to the first charge quantity to a second raster surface associated with the second image element, such that a sub-region of the second raster surface abutting the first raster surface is discharged below the development threshold via the second charge quantity and via a portion of the first charge quantity that acts on the second raster surface or that, via the second charge quantity and via the portion of the first charge quantity that acts on the second raster surface, a sub-region of the second raster surface abutting the first raster surface is charged such that the charge of this sub-region is above the development threshold; and establishing the width of the line to be generated at least by the first raster surface and the sub-region of the second raster surface abutting the first raster surface.

This object is also achieved by a printing system configured to generate a print image, comprising: a conductive layer having a raster surface; matrix-shaped raster cells with which are associated image elements via which a line of a print image is generated, at least one first image element and a second image element of adjoining raster cells establishing a width of the line; a charge supply mechanism via which a charge quantity can be supplied to an image element corresponding to data associated with each image element, via which charge quantity a charge of the raster surface of the conductive layer associated with a respective image element is changed, a the charge modification on the conductive layer ensuing corresponding to a charge distribution curve, and a portion of the charge quantity ensuing for at least one of regions of adjacent raster surfaces abutting the raster surface; wherein a first charge quantity can be supplied to a first raster surface associated with the first image element, the first charge quantity discharging the first raster surface below a development threshold or charging the first raster surface such that the charge of the first raster surface is above the development threshold; a second charge quantity, smaller relative to the first charge quantity, can be supplied to the second raster surface associated with the second image element, such that a sub-region of the second raster surface abutting the first raster surface is discharged below the development threshold via the second charge quantity and via a portion of the first charge quantity that impinges on the second raster surface or that, via the second charge quantity and via a portion of the first charge quantity that acts on the second raster surface, a sub-region of the second raster surface abutting the first raster surface is charged such that the charge of this sub-region is above the development threshold, the width of the line to be generated being established at least by the first raster surface and the sub-region of the second raster surface abutting the first raster surface.

This method is also achieved by a data processing system to convert print data, comprising: a charging mechanism configured to charge a conductive layer; a computer configured to convert source image data of a source image whose source image elements with a predetermined first resolution are arranged corresponding to a first source image raster into target image data of a target image whose target image elements with a second resolution different from the first resolution by a conversion factor are arranged corresponding to a target image raster, the source image data having a word length of one bit; at least one first target image element and a second target image element adjacent to the first target image element establishing a width of a line to be generated; the computer being configured to generate target image data with a word length of at least two bits, wherein, with these target image data, a charge modification of a conductive layer can be controlled with the charging mechanism.

This object is further achieved by a method to generate a print image, comprising: generating a print image that image elements that are associated with matrix-shaped raster cells; establishing a width of a line of the print image from at least one first image element and a second image element of adjoining raster cells; changing a charge of a raster surface of a light-sensitive photoconductor layer associated with the respective image element based on corresponding data associated with each image element via a light quantity emitted with the aid of at least one light source; emitting, by the light source, a portion of the light quantity at least on sub-regions of adjacent raster cells abutting the raster surface, corresponding to its light distribution curve; supplying a first light quantity to a first raster surface associated with the first image element, the first light quantity discharging the first raster surface below a development threshold or charging the first raster surface such that the charge of the first raster surface is above the development threshold; supplying a second light quantity smaller relative to the first light quantity to a second raster surface associated with the second image element, such that a sub-region of the second raster surface abutting the first raster surface is discharged below the development threshold via the second light quantity and via the portion of the first light quantity that impinges on the second raster surface or that, via the second light quantity and via the portion of the first light quantity that impinges on the second raster surface, a sub-region of the second raster surface abutting the first raster surface is charged such that the charge of this sub-region is above the development threshold; and establishing the width of the line to be generated at least by the first raster surface and the sub-region of the second raster surface abutting the first raster surface.

This object is also achieved by a printing system to generate a print image, comprising: a light sensitive photoconductive layer having a raster surface; matrix-shaped raster cells with which are associated image elements via which a line of a print image is generated, at least one first image element and a second image element of adjoining raster cells establishing a width of the line; a light source via which a charge of the raster surface of the light-sensitive photoconductor layer associated with the respective image element is changed with, the light source configured to emit a light quantity corresponding to data associated with each image element, the light source further being configured to emit a portion of the light quantity at least on sub-regions of adjacent raster surfaces abutting the raster surface corresponding to its light distribution curve; the light source being configured to supply a first light quantity to the first raster surface associated with the first image element, the first light quantity discharging a first raster surface below a development threshold or charging the first raster surface such that the charge of the first raster surface is above the development threshold; the light source being further configured to supply a second light quantity smaller relative to the first light quantity to a second raster surface associated with the second image element such that a sub-region of the second raster surface abutting the first raster surface is discharged below the development threshold via the second light quantity and via the portion of the first light quantity that impinges on the second raster surface or that, via the second light quantity and via the portion of the first light quantity that impinges on the second raster surface, a sub-region of the second raster surface abutting the first raster surface is charged such that the charge of this sub-region is above the development threshold; the width of the line to be generated being established at least by the first raster surface and the region of the second raster surface abutting the first raster surface.

Finally, this object is achieved by a data processing system configured to convert print data, comprising: a light source configured to expose a photoconductive layer; a computer configured to convert source image data of a source image whose source image elements with a predetermined first resolution are arranged corresponding to a first source image raster into target image data of a target image whose target image elements with a second resolution different from the first resolution by a conversion factor are arranged corresponding to a target image raster, the source image data having a word length of one bit; at least one first target image element and a second target image element adjacent to the first target image element establishing a width of a line to be generated; the computer being configured to generate target image data with a word length of at least two bits, wherein, with these target image data, the light source can be activated for exposure of a photoconductor layer.

In the inventive method, with the aid of at least one light source, a light quantity is emitted corresponding to data associated with each image element. The charge of a raster surface of a light-sensitive photoconductor layer associated with the respective image element is changed via the emitted light quantity. Corresponding to its light distribution curve, the light source also emits a part of the light quantity at least on regions of adjacent raster surfaces abutting the raster surface. A first light quantity is supplied to the first raster surface associated with the first image element. A second light quantity different from the first light quantity is supplied to the second raster surface associated with the second image element. The light quantity supplied to the abutting raster surfaces is comprised for the first raster surface from the part of the first light quantity impinging on this region and the part of the second light quantity impinging on this region. The light quantity supplied to the edge region of the second raster surface is comprised from the part of the second light quantity impinging on this region and the part of the first light quantity impinging on this region.

The dimensions of the region whose charge is changed by the supplied first and second light quantities can be very precisely controlled via the variation of the first and/or second light quantity and are independent of the optical properties of focusing optics associated with the light source. The region of both raster surfaces whose charge is changed by the first and second light quantities determines the line width of the line of the print image to be generated. The width of a line to be printed can be simply controlled or, for example, given detection of the width of the printed line, even regulated via the inventive method. The line width can be precisely adjusted via the inventive method such that, upon precise observation of the target print image, a target print image optically coincides with the associated source print image, even when a non-whole-number conversion factor is present by which the resolution of the target print image differs from the resolution of the source print image.

Predetermined desired widths of lines can be achieved exactly. For the machine readability of “barcodes”, the line width of the lines contained in the barcode is in particular significant for error-free recognition of the barcode. However, the line width can also be adapted via the inventive method in order to attain a print image compatibility at another printing system. The print images of a plurality of printing systems can thereby be exactly tuned to one another, such that identical print images are generated given the same print data. In printing systems that have (dependent on printing principles) an anisotropy of horizontal and vertical line widths, an adaptation of the horizontal and vertical line widths can be achieved via the inventive method.

In an advantageous embodiment of the invention, the second light quantity is smaller than the first light quantity. The first raster surface is discharged below a second potential via the first light quantity. A region of the second raster surface bordering the first raster surface is discharged below the second potential via the second light quantity and via the portion of the first light quantity that impinges on the second raster surface.

It is thereby advantageous when the light sources can be activated in at least three levels, whereby the raster surface is not discharged to a preset potential in a first level, is partially discharged to a preset potential in a second level and is nearly completely discharged to a preset potential in a third level. Depending on the printing system, only the charged areas or only the discharged areas are inked with toner upon development of the latent charge image generated by the light sources. Via the possibility to supply a smaller light quantity to individual raster surfaces than to other raster surfaces, areas that extend over a plurality of raster cells can be inked with toner, whereby the outer borders of this area do not have to coincide with borders of raster surfaces. It is thereby possible to nearly arbitrarily position the outer borders of areas (for example, of lines) on a carrier material.

In a further embodiment of the invention, the second potential is a development threshold in the development of the charge image of the photoconductor layer with toner. Only the regions of the photoconductor layer whose charge is charged or discharged above or below the second potential are thereby inked with toner. The external boundaries of the surfaces to be inked can thereby particularly easily be determined.

In another advantageous embodiment, the line to be generated with the aid of the inventive method is the edge line of a region to be inked with toner. Raster surfaces of image elements that are not to be inked with toner are thereby exposed, whereby the second image element is arranged on the outer edge of the region that is not to be inked. This permits the external boundaries of the surface to be inked with toner to be particularly easily modified.

As an alternative to this, the generated line is the edge line of a region to be inked with toner. Raster surfaces of image elements that are to be inked with toner are thereby exposed. The second image element is arranged at the outer edge of the region to be inked. In this alternative embodiment, the outer edges of the surface to be inked can likewise be simply adjusted.

In a further embodiment of the invention, the inventive method is used in order to convert from source image data of a source image whose source image elements are arranged with a predetermined first resolution (for example, 400 dpi) corresponding to a source image raster into target image data of a target image whose target image elements are to be arranged with a different second resolution (for example, 600 dpi) deviating from the first resolution by a conversion factor (for example, 1.5) corresponding to a target image raster. If a line should thereby be printed whose line width in the source image raster is one raster surface wide, this is to be represented in the target image raster with a width of 1.5 raster surfaces.

However, in known printing systems and methods to generate a print image, this is not possible. But, with the aid of the inventive method, line widths can also be generated with nearly arbitrary widths, independent of the existing target image raster. The target print image can thereby be very simply adapted such that it optically coincides with the source print image.

In a development of this embodiment, the source image is divided into matrix-shaped partial images. For each partial source image, corresponding target image data are determined from the associated source image data for a corresponding partial target image according to calculation operations identical for all sub-images. The position of the partial target image in the target image coincides with the position of the associated partial source image in the source image. With the aid of the partial images, it is particularly simply possible to convert the source image data into target image data. For the conversion of the source image data into target image data for each sub-image, only a relatively small calculation capacity is necessary.

In another embodiment of the invention, the source image data of each source image element has a word length of 1 bit. With the aid of the inventive method, target image data are generated, whereby the target image data of a target image element have a word length of at least 2 bits. The light sources to modify the charge of the photoconductor layer can thereby be activated in at least three levels, whereby the light source respectively emits a light quantity in at least 2 levels, and whereby both light quantities differ.

The conversion of the source image data into target image data can thereby ensue via hard-wired logic and/or via a program module whose commands are executed via a data processing system. The target image data can thereby be generated from source image data with calculation units and/or logic circuits that are already present in known printing systems. However, it is also possible to implement the inventive conversion of the source image data into target image data with the aid of a separate data processing system.

In a further advantageous embodiment of the invention, the light source can be triggered in 64 levels, whereby each level emits a different light quantity. The line width of the line to be generated can thereby be precisely varied in very small steps. The light quantity can be simply controlled via the intensity of the light source and/or via the activation duration of the light source.

In a particularly advantageous embodiment of the invention, the line width of printed lines is determined via a sensor arrangement. The determined line width is compared with a default value. Depending on the comparison result, the line width of subsequent print images is adapted in that the charged and discharged print regions are changed corresponding to the comparison result. Print images of different printing systems can thereby be very simply standardized. Given printing system-dependent different line widths of perpendicular and vertical lines, the line width of these lines can be adapted with the aid of this development such that a uniform line width is achieved.

Via an inventive electrophotographic printing system to generate a print image, it is achieved that the line width of lines to be generated can be generated independent of matrix-shaped raster cells which are associated with image elements. The line widths can thus be simply adapted to line widths of other printing systems, whereby the print images of different printing systems can be standardized. Even given printing system-dependent deviations of line widths of vertical and horizontal lines, a correction with the aid of the inventive printing system is simply possible.

With the aid of an inventive data processing system, source image data are converted into target image data such that, with the aid of the target image data, a light source to expose a raster cell of a photoconductor layer can be triggered in a plurality of levels, whereby only regions of target image elements are also inked given subsequent development of the exposed photoconductor layer with toner. It is thereby possible that a target image whose inked areas exhibit a high degree of coincidence with the inked areas of the source image can be generated with the aid of the target image data.

### DESCRIPTION OF THE DRAWINGS

Further features and advantages of the invention result from the following description, which explains the invention in detail in connection with the attached drawings using exemplary embodiments.

FIG. 1 is a pictorial diagram illustrating two source images with a resolution of 240 dpi;

FIG. 2 is a pictorial diagram illustrating a target image with a resolution of 600 dpi;

FIG. 3 is a pictorial diagram showing a partial source image with a resolution of 240 dpi and an associated partial target image with a resolution of 600 dpi;

FIG. 4 is a block diagram of a Boolean combinatorial circuit to convert source image data into target image data;

FIG. 5 is a pictorial diagram showing two source images with a resolution of 400 dpi;

FIG. 6 is a pictorial diagram showing a target image with a resolution of 600 dpi;

FIG. 7 is a pictorial diagram showing a partial source image with a resolution of 400 dpi and an associated partial target image with a resolution of 600 dpi;

FIG. 8 is a block diagram of a Boolean combinatorial circuit to convert source image data with a resolution of 400 dpi into target image data with a resolution of 600 dpi;

FIG. 9 is a flowchart illustrating a conversion of source image data into target image data;

FIG. 10 is a pictorial diagram showing a source image with a resolution of 240 dpi in which a line is shown with a width of 1 pixel;

FIG. 11 is a pictorial diagram showing the association of the target image data with raster cells in order to represent the line according to FIG. 10 with the aid of a 600 dpi printing system;

FIG. 12 is a pictorial diagram of the line generated from the target image data according to FIG. 11 with the aid of the 600 dpi printing system;

FIG. 13a is a graph in which the charge of the photoconductor layer resulting for three adjacent raster cells via the light quantity impinging on these raster cells is shown, whereby the third raster cell is supplied a reduced light quantity;

FIG. 14 is a graph in which the charge for three adjacent raster cells resulting after the supply of the light quantity is shown, whereby the light quantity impinging on the third raster cell is further reduced relative to FIG. 13;

FIG. 15 is a graph similar to the graphs according to FIGS. 13 and 14, whereby the third raster cell is supplied the same light quantity as the first two raster cells;

FIG. 16 is a pictorial diagram showing the target image data associated with raster cells given a conversion of the source image data according to FIG. 10 with the aid of a known method;

FIG. 17 is a pictorial diagram showing a target image corresponding to the target image data according FIG. 16; and

FIG. 18 is a flowchart illustrating and embodiment of the inventive conversion of source image data into target image data.

### DETAILED DESCRIPTION OF THE PREFERRED EMBODIMENTS

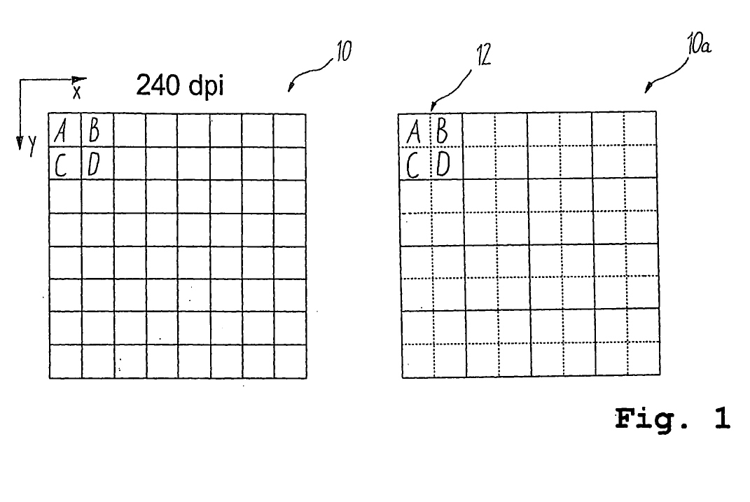

FIG. 1 shows a strongly magnified source image 10 with a resolution of 240 dpi (pixels per inch, 1 inch=25.4 mm). The source image 10 contains quadratic source image elements arranged matrix-shaped. A first source image element that is designated with A is arranged in the first column in the x-direction and in the first row in the y-direction. A second source image element is designated with B and arranged in the second column in as well as in the first row. A third source image element designated with C is arranged in the first column of the second row. The source image element designated with D is arranged in the second column of the second row.

Further source image elements are arranged matrix-shaped in the eight rows and eight columns of the source image. In FIG. 1, furthermore, a source image 10a is shown that significantly corresponds with the source image 10. Four source image elements of the FIG. 1 that respectively form a square are respectively associated with a partial source image 12. The source image elements A, B, C, D form the partial source image 12. The edges of the partial source images 12 are shown with continuous lines. The edges of the source image elements A, B, C, D contained in the partial source images 12 are shown with dashed lines.

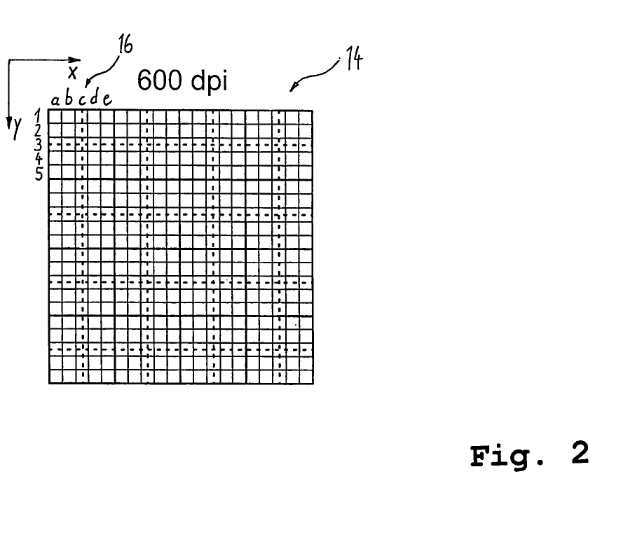

A strongly magnified target image 14 with a resolution of 600 dpi is shown in FIG. 2. The target image 14 is divided into partial target images, of which a first partial target image 16 is indicated. The edges of the partial target images are shown with thick continuous lines. The area of the partial target image 16 coincides with the area of the partial source image 12. The partial target image 16 contains 25 quadratic target image elements arranged matrix-shaped. The columns of the partial target image 16 arranged in the x-direction are designated with a, b, c, d, e and the rows of the partial target image 16 arranged in the y-direction are designated with 1, 2, 3, 4, 5. The edges of the areas that correspond to the source image elements A, B, C, D of the source images 10, 10a are shown with dashed lines. In the following, corresponding to their position, with the aid of the column and row coordinates, the target image elements of the partial target image 16 are designated with: a1, a2, a3, a4, a5, b1, b2, b3, b4, b5, c1, c2, c3, c4, c5, d1, d2, d3, d4, d5, e1, e2, e3, e4, and e5.

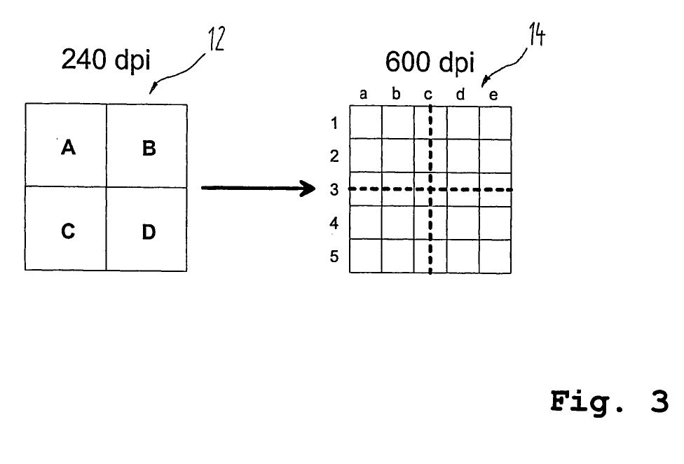

In FIG. 3, the partial source image 12 is shown with a resolution of 240 dpi and the partial target image is shown with a resolution of 600 dpi. The source image element A of the partial source image 12 corresponds to the target image elements a1, b1, a2, b2 as well as to parts of the target image elements c1, c2, a3, b3, c3.

The area of the source image element A of the partial source image 12 corresponds to the left upper region of the partial target image 16 divided off by dashed lines. The area of the source image element B of the partial source image 12 corresponds to the area of the target image elements d1, e1, d2, e2, and parts of the target image elements c1, c2, c3, d3, e3. The area of the source image element B of the partial source image 12 corresponds to the right upper region segmented by the dashed lines in the partial target image 16.

The area of the source image element C of the partial source image 12 corresponds to the left lower region bordered by the dashed lines in the partial target image 16, with the target image elements a4, b4, a5, b5 and parts of the target image elements a3, b3, c3, c4, c5. The area of the source image element D of the partial source image 12 corresponds to the right lower region of the partial target image 16 bordered by the dashed lines and contains the target image elements d4, e4, d5, e5 as well as parts of the target image elements c3, d3, e3, c4, c5.

The source image element A of the partial source image 12, which has a resolution of 240 dpi, is thus represented in the partial target image 16 with a resolution of 600 dpi with the aid of four target image elements a1, b1, a2, b2 as well as with regions of the target image elements c1, c2, a3, b3, c3. The conversion factor is 2.5.

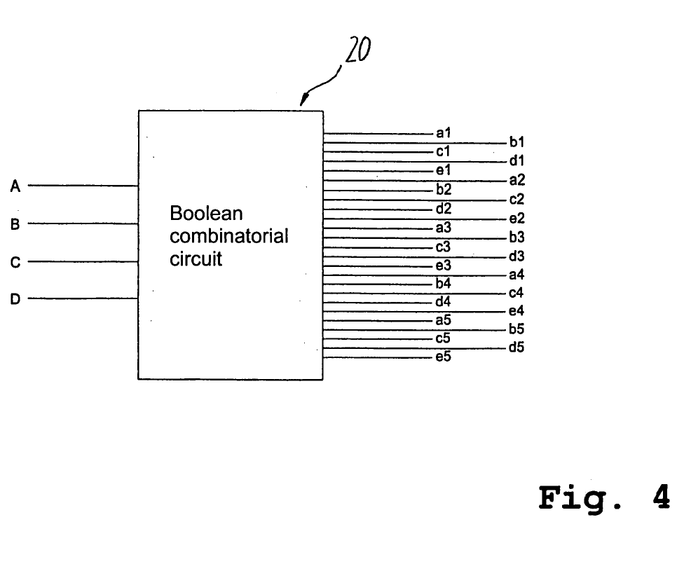

In FIG. 4, a block diagram of a Boolean combinatorial circuit 20 is shown with whose help target image data of the target image elements a1 through e5 of the partial target image 16 of the target image 14 are generated from the source image data A, B, C, D of the partial source image 12. The source image elements A, B, C, D of the source image 10 are preferably combined into the partial source image 12, such that they yield a partial target image 16 that contains a whole-number number of target image elements a1 through e5. The conversion factor results from the number of target image elements via which a source image element A must be shown in the x-direction and in the y-direction in the target image 14 in order to allocate the same area of the source image element A in the target image 14. Source image data that determine the representation of the respectively associated source image element A, B, C, D are present for each source image element A, B, C, D.

The source image data of each source image element A, B, C, D have a word length of 1 bit, whereby the logical value 0 defines a white source image element A, B, D, C and the logical value 1 defines a source image element A, B, C, D inked with toner. Depending on the toner color, the associated source image element A, B, C, D should be represented in the source print image as an area inked with toner. The source image data are preferably appropriately stored in storage cells of a storage of a data processing system such that source image data for successive source image elements of a source image row are stored in storage cells with ascending storage addresses.

The target image data of the target image elements a1 through e5 are generated with the aid of the Boolean combinatorial circuit 20 from the source image data of the source image elements A, B, C, D. The conversion of the source image data into target image data can thereby ensue via hard-wired logic and/or via a program module of the Boolean combinatorial circuit 20, whereby the commands of the program module are executed via a data processing system. The target image data of the target image elements a1 through e5 have a word length of 2 bits. Should, for example, the source image elements A and C be inked and the source image elements B and D not be inked, the target image elements c1 through c5 only have to be half-inked in order to ink exactly the same area of the target print image that is inked in the printout of the source print image on a corresponding printer.

The target print data have, as already mentioned, a word length of 2 bits, whereby they can contain up to four items of display information. With the aid of this display information, the emitted light quantity of a light source to expose a raster surface of a light-sensitive photoconductor layer associated with the respective image elements a1 through e5 can be designed of a type that, given subsequent development of this photoconductor layer with toner, the area of the target image element a1 through e5 is not inked, is slightly inked, is approximately half-inked or is entirely inked. The respective inked region is (at least given a partially inked raster cell, for example, a half-inked raster cell) also dependent on the light quantity that the light source emits, corresponding to its light distribution curve of adjacent raster cells, on the raster cell to be partially inked.

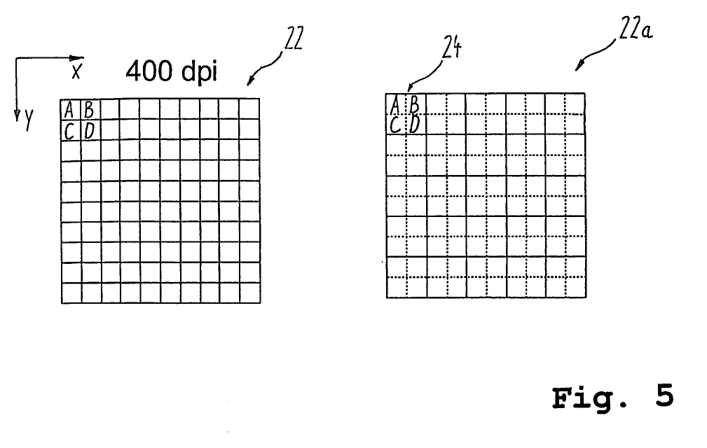

In FIG. 5, two source print images 22, 22a with a resolution of 400 dpi are shown in a strongly magnified representation. The source images 22, 22a significantly coincide with the source images 10, 10a. The source image elements, of which four are designated with A, B, C, D, are associated with raster cells arranged matrix-shaped. Source print data are associated with each source image element A, B, C, D. Respectively four raster cells of source image elements A, B, C, D are respectively associated with a quadratic partial source image, whereby the edges of the partial source images are represented with continuous lines and the edges of the source image elements A, B, C, D are represented with dashed lines in the source print image 22a. The four source image elements A, B, C, D are combined into a partial source image 24.

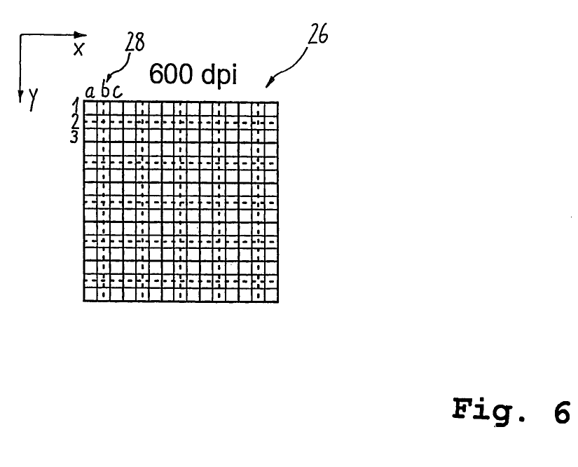

A target print image 26 is shown in FIG. 6. The target print image 26 comprises target image elements that are associated with quadratic raster cells arranged matrix-shaped. The target print image 26 has a resolution of 600 dpi. The conversion factor from source print image 22 to target print image 26 is 1.5. The areas of the source image elements A, B, C, D are respectively given by dashed lines in the target print image 26. The source image element A of the source image 22 is represented in the target image 26 by the target image element a1 and parts of the target image elements b1, a2, b2. The source image element B of the source image 22 is represented in the target image 26 by the target image element c1 as well as by parts of the target image elements b1, b2 and c2. In the target image 26, the source image element C of the source image 22 is represented by the target image element a3 as well as by parts of the target image elements a2, b2, b3. The source image element D of the source image 22 is represented by the target image element c3 as well as by parts of the target image elements b2, c2 and b3. The target image elements a1 through c3 of the target image 26 yield the partial target image 28. The area of the partial target image 28 coincides with the area of the partial source image.

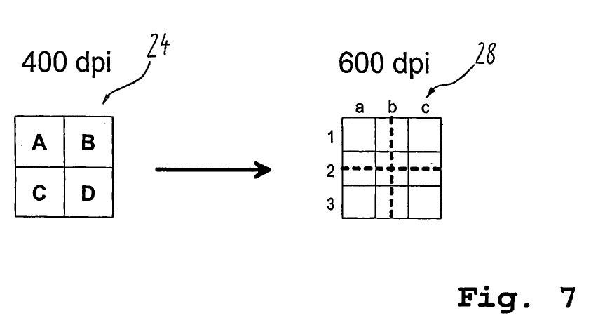

In FIG. 7, the partial source image 24 is shown with the source image elements A, B, C, D and the partial target image 28 is shown with the target image elements a1 through c3. The dashed lines in the partial target image 28 thereby specify the edges of the areas of the source image elements A, B, C, D in the partial target image 28. The source print data of the source image elements A, B, C, D are converted into target image data of the target image elements a1 through c3 corresponding to their image information. Given a non-whole-number conversion factor, an areally exact representation of the source image elements A, B, C, D with a resolution of 400 dpi with a printing system with a resolution of 600 dpi is difficult, since not all edges of the source image elements A, B, C, D coincide with edges of the target image elements a1 through c3, and only parts of the target image elements b1, b2, b3 as well as a2, b2, c2 must result in a different inking of the source image elements A, B, C, D in order to obtain an exactly coincidental representation of the source print image 22 with the target print image 26.

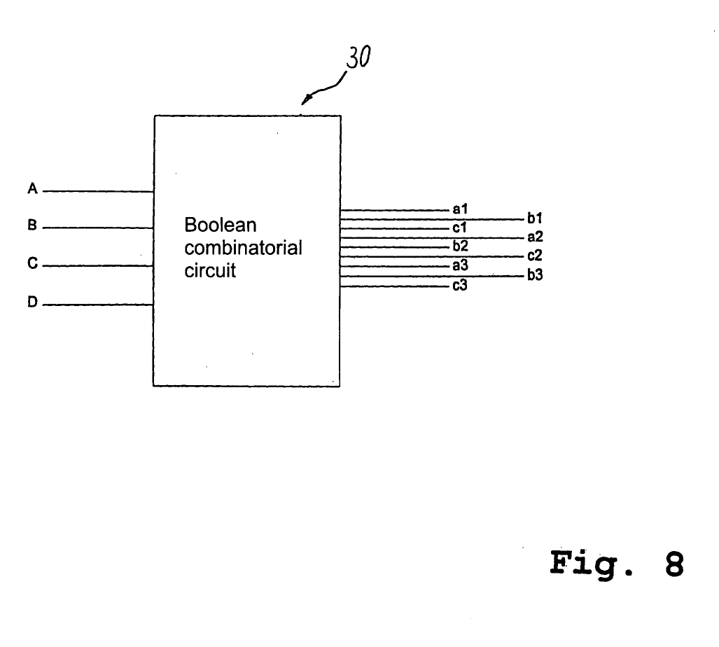

FIG. 8 is a block diagram of a Boolean combinatorial circuit 30 to be generated for conversion of the source print data of the source image elements A, B, C, D into target print data of the target image elements a1 through c3. As already specified in connection with FIG. 4, the source image data typically have a word length of 1 bit and the target image data have a word length of at least 2 bits so that the target print data can contain information that is supplied for control to a raster surface of a light-sensitive photoconductor layer associated with the respective target image element a1 through c3, such that this raster surface is either not inked with toner, or is approximately quarter-inked with toner, or is approximately half-inked with toner, or is completely inked with toner upon later development of the photoconductor layer with toner.

As already specified in connection with FIG. 4, the Boolean combinatorial circuit 30 can contain hard-wired logic circuits and/or a program module whose commands are executed by a data processing system. The source print data of the source image elements A, B, C, D respectively of a partial source image 24 are supplied in the Boolean combinatorial circuit 30. The Boolean combinatorial circuit 30 generates the target image elements a1 through c3 of the partial target image 28 associated with the partial source image 24 from these source print data.

In other embodiments of the invention, the target print data have a word length of at least 6 bits, whereby the light source can be triggered in 64 levels and emits a different light quantity at each level. The light quantity can thereby be controlled via the intensity and/or the activation duration of the light source.

For each partial source image 24, an associated partial target image 28 is determined from the source image data after calculation operations identical for all partial source images. The partial target image 28 is thereby arranged at a position in the target image 26 that coincides with the position of the associated partial source image 24 in the source image 22. For target image elements b1, b2, b3, a2, c2, whose raster surface in the source image contains partial regions of at least two source image elements A, B, C, D, the target image data are generated corresponding to the areal portions of the source image elements A, B, C, D on the target image element b1, b2, b3, a2, c2 and the source image data of these source image elements. Above all else, when the conversion factor contains a decimal fraction with an arbitrary numerical value and a place value of 5, it is advantageous to establish a partial source image 24 from respectively four source image elements A, B, C, D that form a square. Target image data can thereby be determined with the smallest-possible partial source images 24 relative to the source image data of the source image elements A, B, C, D with the aid of the Boolean combinatorial circuit 20, 30.

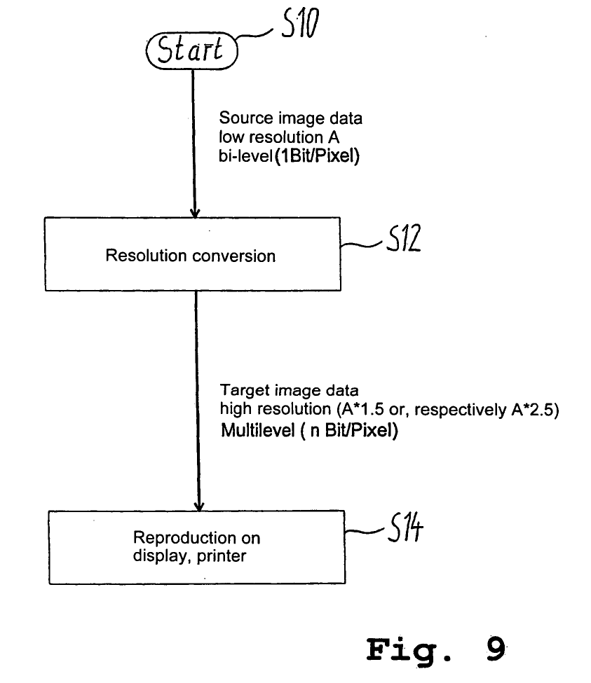

A flow plan for reproduction of source image data on a reproduction system of higher resolution is shown in FIG. 9. The process begins in step S10. A resolution conversion ensues in step S 20, whereby source image data are present with a first resolution A, for example with a resolution of 240 dpi. The source image data have a word length of 1 bit and are suitable for triggering of a character generator in what is known as a “bi-level mode”. With the aid of a light source, a character generator triggered in the bi-level mode supplies a preset light quantity to a raster cell when the image data for this raster cell have, for example, the logical value 1. However, if the image data for a raster cell have a logical value 0, the character generator thus supplies no light quantity to this raster cell.

In step S20, for example with the aid of a Boolean combinatorial circuit 20, 30, these source image data are converted into target image data that have a higher resolution and a data word length of at least two bits. If the target image resolution is, for example, 600 dpi, and the source image resolution is 240 dpi, the source image data are converted with the aid of a conversion factor with the value 2.5. Given a source image resolution of 400 dpi and a target image resolution of 600 dpi, the source image data are converted into target image data with a conversion factor of 1.5. The conversion factor specifies how many target image elements are necessary in the x-direction and in the y-direction in order to fill up the same surface in the target image 26 that the source image element A, B, C, D takes up in the source image 22.

In other exemplary embodiments, if, for example, a resolution of 400 dpi is to be converted into a target image 26 that horizontally has a resolution of 1200 dpi and vertically has a resolution of 600 dpi, for the source image elements A, B, C, D a conversion factor of 3 is to be used in the horizontal direction and a conversion factor of 1.5 is to be used in the vertical direction. In particular, given conversion factors that contain a decimal fraction, it is advantageous to generate image data with a world length of at least 2 bits as target image data.

Four signal states can be represented by target image data with a word length of 2 bits, whereby with the aid of a “multi-level character generator”, it is possible to supply a different light quantity (depending on the signal state) to the raster surface of the photoconductor layer belonging to the respective target image element a1 through c3. Given a first signal state, the light source can thereby supply a preset first light quantity. Given a second signal state, the light source can then supply a light quantity that approximately corresponds to 0.7 times the first preset light quantity to the raster surface. Given the third signal state, the light source supplies a third light quantity that approximately corresponds to half of the first light quantity to the raster surface. Given the fourth signal state, the light source supplies no light to the raster surface.

If the data of a source image element A of a source image with a resolution of 400 dpi are converted into target image data of a target image with a resolution of 600 dpi, the source image element A of the source image 22 corresponds in the target image 26 with a line that is 1.5 target image elements wide and 1.5 target image elements long. The source image data A contains the logical value 1, such that the associated raster surface of the source image element A is to be inked with toner. The remaining image elements B, C, D of the source image 24 are not to be inked with toner. The already-defined signal state 1 thereby results for the target image data of the target image element a1; the second signal state respectively results for the target image element b1, a2, b2. With the aid of the light quantity supplied to the respective raster surface, in the printing system used in the exemplary embodiment, a photoconductor layer charged to a set potential is discharged in the region of this raster cell. In the subsequent development event of the photoconductor layer with toner, this raster surface is then inked with toner when it has been discharged below a predetermined second potential, what is known as the “development threshold”.

The first light quantity is preset such that the raster cell is supplied so much light that it is completely inked with toner upon development. The light source with whose help this light quantity is supplied to the raster surface emits the light corresponding to a light distribution curve.

With the aid of optics, the light is focused on a region in which the raster surface is contained. However, with focusing optics, a light distribution curve also results that, for example, resembles a three-dimensional Gaussian curve. The light quantity is set such that sufficient light energy is also supplied to the boundary regions of the raster cell to be exposed, in order to also discharge the raster surface in these regions below the second potential. The second potential is also designated as a development threshold.

A part of the light quantity is thereby emitted onto abutting regions of adjacent raster surfaces. The first light quantity is thus supplied to the raster cell a1 and the second light quantity, which corresponds to approximately 0.7 times the first light quantity, is thus supplied to the raster cell b1. Upon development with toner, due to the second light quantity, the raster cell b1 would only be inked in a very small region around its center point. However, the region of the raster cell b1 abutting the raster cell a1 is also discharged by a part of the first light quantity that is emitted on the raster cell b1 upon exposure of the raster cell a1. Together with the second light quantity that is supplied to the raster cell b1 by the light source, approximately half of the raster cell b1 is discharged below the development threshold, such that approximately half of the raster cell b1 abutting the raster cell a1 is inked with toner.

If, for example, the raster cell b1 is only exposed with 0.5 times the light quantity of the first light quantity, which corresponds to the third signal state, a region of the raster cell b1 abutting the raster cell a1 would be discharged below the development threshold that approximately corresponds to a third of the width of the raster cell b1. It would then form a contiguously inked area that has an expanse of 1.33 raster cells.

If, in this exemplary embodiment, the second light quantity is supplied to the raster cell a2, this raster cell is approximately half-inked with toner in the y-direction after the development with toner. If the second light quantity is supplied to the raster cell b2, the second light quantity supplied to the raster cell b2 is discharged below the second potential only in a region abutting the raster cells a1, b1, a2, to which region is supplied a correspondingly large light quantity upon exposure of the raster cells a1, b1, a2.

An inked region that corresponds to the raster surface of the target image element a1 as well as approximately to the region of the raster cell b1 abutting the raster cell a1 and to the part (which corresponds to approximately a quarter of the raster cell b2) of the raster cell b2 abutting the raster cells a1, b1, a2 thereby results in the target image 26. Thus a square that approximately corresponds to the source image element A of the source image 22 is inked with toner. The target image 26 thus optically nearly identically reproduces the source image 22. The reproduction of the target image data ensues in step S14 on a display unit or a printer.

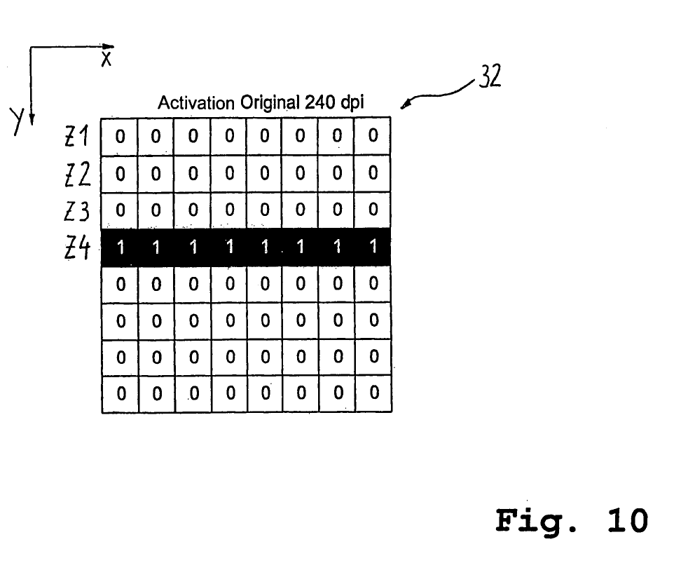

A source image 32 is shown in FIG. 10. The source image 32 contains source image elements arranged matrix-shaped with a resolution of 240 dpi. The source image data of the fourth row Z4 of the source image 32 all have the signal state 1, whereby a horizontal line is described in the source image 32 that is shown as a black bar in the row Z4 of the source image 32. The white digits contained in this black bar specify only the logical signal state of the contained source image elements.

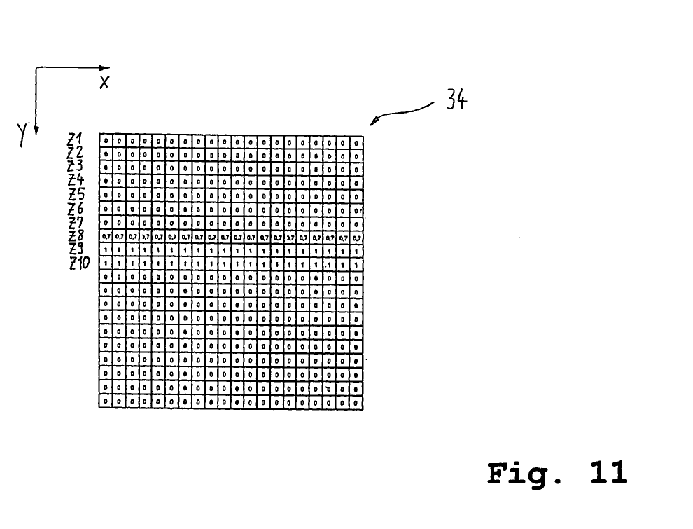

A matrix-shaped arrangement 34 of target image data corresponding to the raster of a target image is shown in FIG. 11. With the aid of the target image data, the light sources of the character generator of the printing system should be activated such that nearly the same area is inked in the target image that is inked in the source image 32 according to FIG. 10 via the image elements of the fourth row Z4. After the conversion of the source image data into target image data with the aid of the Boolean combinatorial circuit 20, 30, the target image data of all target image elements of the eighth row Z8 of the target image have the value 0.7, and all target image elements of the ninth Z9 and tenth Z10 row have the value 1.

All target image data of the target image elements of the target image have the value 0. The target image data specify the factor with which a preset value of the maximum light quantity to be output by the light sources of the character generator is multiplied in order to determine the light quantity to be emitted by the light source on the respective raster surface of the photoconductor layer. Thus 0.7 times the set light quantity is emitted on the raster surfaces associated with the target image elements of the eighth row and the set light quantity is respectively emitted on the raster surfaces of the target image elements of the ninth Z9 and tenth Z10 row. No light is emitted on the raster surfaces of the remaining target image elements.

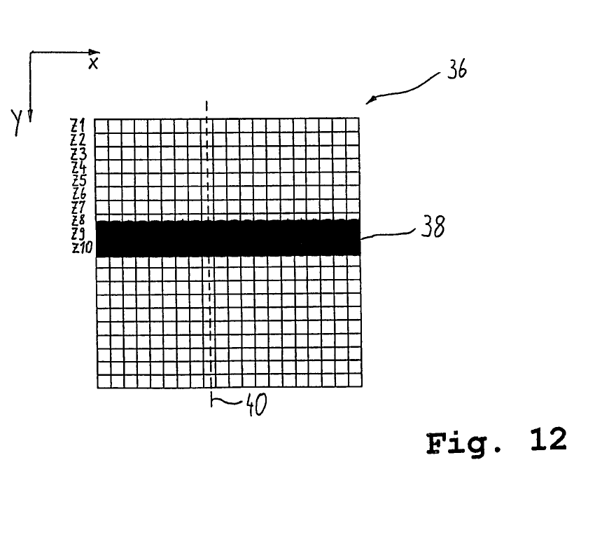

A target image 36 with a resolution of 600 dpi is shown in FIG. 12. The solid lines clarify only the edges of the quadratic raster cells and are not shown in the target print image to be generated. The region of the target image 36 to be inked with toner comprises the target image elements of the rows Z9 and Z10 as well as respectively one region of the target image elements of the row Z8 that borders the target image elements of the row Z9. The inked regions of the row Z8, together with the target image elements of the rows Z9 and Z10, form a uniform inked area 38. 0.7 times the light quantity that has been supplied to the raster surfaces of the target image elements of the rows Z9 and Z10 has been supplied to the raster surfaces of the photoconductor layer associated with the target image elements of the row Z8.

The light quantity that has been supplied to the raster cells of the target image elements of the rows Z9 and Z10 discharges the entire area of the respective raster surface such that the photoconductor layer on this surface is discharged such that all regions of the raster surface are discharged below a second potential, what is known as the “development threshold”. Upon supply of this light quantity to the raster surfaces, particularly to the raster surfaces of the target image elements of the row Z9, a part of the light quantity emitted by the light source is also emitted onto a region of the raster cells of the target image elements of the row Z8 bordering the raster surfaces of the target image elements of the row Z9. In the present exemplary embodiment, the light distribution curve of the light sources, as already mentioned, resembles a three-dimensional Gaussian distribution, whereby the point with the largest supplied light quantity lies approximately in the center point of the respective raster cell.

Due to the light quantity supplied to the raster cells of the row Z8 upon exposure of the raster cells of the row Z9 and the light quantity supplied to the raster cells of the row Z8, only the part of the raster cells of the row Z8 that borders the raster cells of the row Z9 is discharged below the development threshold. Only a part of the area of the raster cells of the row Z8 is thereby inked with toner upon development of the photoconductor layer.

If approximately 0.7 times the light quantity that is supplied to the raster cells of the rows Z9 and Z10 is supplied to the row Z8, approximately half of the area of the raster cells of the row Z8 is discharged, such that it is inked with toner upon a development. If, based on the existing target image data, a larger light quantity is supplied to the raster cells of the row Z8, for example 0.8 times the light quantity, a larger region of the raster cells of the row Z8 is discharged below the development threshold. For example, approximately 3/4 of the area of the raster cells of the row Z8 is thereby inked with toner upon development.

However, if 0.5 times the light quantity is supplied to the raster cells of the row Z8, approximately only 1/4 of the area of the raster cells of the row Z8 is discharged below the development threshold, such that only approximately 1/4 of the area of the raster cells of the row Z9 is inked with toner upon subsequent development with toner, whereby this region is immediately bordering the raster cells of the row Z9. The area 38 inked with toner in the target print image 36 significantly corresponds to the area inked in the source image 32 via the source image elements of the row 4.

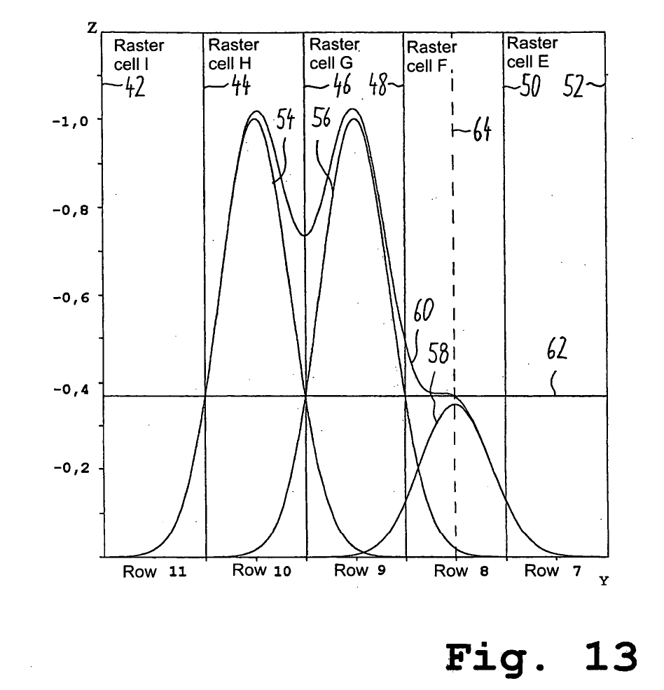

In FIG. 13, a graph is provided that shows the charge distribution along the dashed line 40 (drawn in FIG. 12) on the photoconductor layer after the exposure with the aid of the light source for the rows Z7 through Z11. The raster cells of adjacent rows Z7, Z8, Z9, Z10, Z11 are represented by perpendicular solid lines that are designated 42 through 52. The raster cells of the row Z7 through which the dashed line 30 runs is designated in the following as E; the raster cell of the row Z8 is designated F; the raster cell of the row Z9 is designated G; the raster cell of the row Z10 is designated H; and the raster cell of the row Z11 is designated 1. The position of the raster cells along the dashed line 40 is plotted on the abscissa Y and the potential or the charge of the photoconductor layer is plotted on the ordinate Z.

With the aid of the light source, a first light quantity is supplied to the raster cell H, whereby this raster cell H is discharged corresponding to the graph 54. The horizontal solid line that is designated 62 specifies the development threshold. The graph 54 intersects the development threshold 62 at the borders of the raster cell H to the raster cells I and G. The raster cell H is thereby strongly discharged such that the entire raster cell H is inked with toner upon development of the photoconductor layer.

A part of the light quantity is supplied to the raster cell I and to the raster cell G upon exposure of the raster cell H. The raster cells I and G are only relatively slightly discharged by this light quantity. The raster cell I is only slightly discharged such that no region of the raster cell I is inked with toner upon subsequent development of the photoconductor layer. The same light quantity as is supplied to the raster cell H is supplied to the raster cell G by the light source. The raster cell G is thereby discharged corresponding to the graph 56. Just as with the raster cell H, upon exposure of the raster cell H, a part of the light is emitted on the adjacent raster cells, whereby regions of these raster cells are further discharged depending on light intensity.

Approximately 0.7 times the light quantity that was respectively supplied to the raster cell H and G is supplied to the raster cell F with the aid of the light source. The raster cell F is discharged via this supplied light quantity corresponding to the graph 58, whereby a portion of this light quantity is emitted on the adjacent raster cells similar to in the exposure of the raster cells H and G. At least regions of adjacent raster cells F, G, H are thereby not only discharged by the light quantity that is supplied to these raster cells by the light source, but rather also via the portion of the light quantity that is emitted onto this raster cell upon exposure of the adjacent raster cell.

After the exposure of the raster cells F, G and H, an overall discharge curve results that is represented by the graph 60. The graph 60 is the sum graph of the graphs 54, 56, 58. The graph 60 intersects the development point 62 approximately after half of the raster cell F. Given subsequent development of the photoconductor layer with toner, as already mentioned, only the regions that have been discharged below the development threshold 62 are inked with toner. Thus the region between the line 44 and the dashed line 64 is inked with toner, whereby this region corresponds to approximately a width of 2.5 raster cells.

Upon exposure of the raster surfaces of the raster cells F, G, H, naturally a part of the light quantity is also emitted on adjacent raster cells of the respectively identical row Z8, Z9, Z10. If all raster cells of the rows Z8, Z9, Z10 are exposed in the same manner as the raster cells F, G, H, an inked region that corresponds to the representation of the target print image 36 according to FIG. 12 results after the development with toner. A line is thereby generated that has a width of approximately 2.5 raster cells and, as already mentioned, corresponds to a line width of the source print image 32 according to FIG. 10.

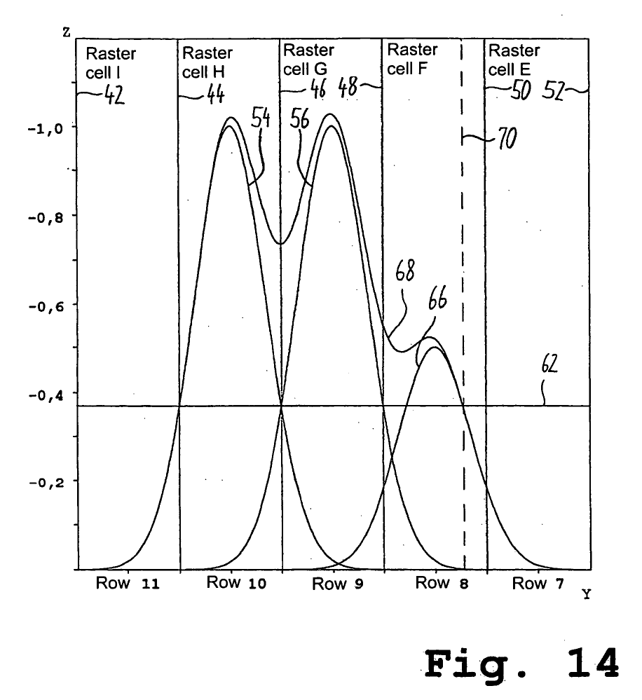

A diagram similar to the diagram according to FIG. 13 is shown in FIG. 14. Identical elements bear identical reference characters. In contrast to FIG. 13, approximately 0.85 times the light quantity that was supplied to the raster cells G and H is supplied the raster cell F of the row Z8. The raster cell F is thereby discharged corresponding to the graph 66. The light quantities supplied to the raster cells F, G, H superimpose in the same manner as was already described in connection with FIG. 13. A curve corresponding to the graph 68 thereby results for the total discharge of the raster cells E through 1.

The graph 68 is the sum graph of the graphs 54, 56, 66. In contrast to FIG. 13, according to the diagram of FIG. 14, a larger region of the raster cell F is discharged below the development threshold. Upon subsequent development with toner, a larger region of the area associated with the raster cell F on the photoconductor layer is thereby inked with toner. This region extends from the line 44 to the dashed line 70, whereby approximately one width of 2.8 raster cells is inked. The line width of the line to be printed according to FIG. 12 can thereby be enlarged to 2.8 raster cells.

However, if a smaller light quantity is supplied to the raster cell F, for example, 0.6 times the light quantity that is supplied to the raster cells G and H, the line width can be reduced to approximately 2.2 raster cells. Nearly any other arbitrary line width can also be generated via variation of the supplied light quantity.

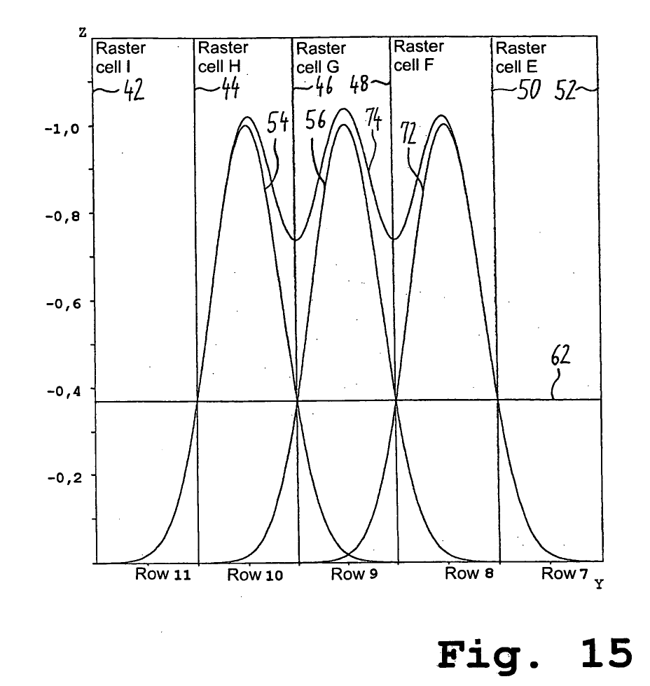

A diagram similar to the diagrams according to FIGS. 13 and 14 is shown in FIG. 15. However, the same light quantity is supplied to the raster cell F as to the raster cells G and H. The raster cell F is thereby discharged just like the raster cells G and H. The discharge of the raster cell F is represented in FIG. 15 by the graph 72. The total discharge of the raster cells E, F, G, H, I results from the sum graph 74 of the graphs 54, 56, 72. The raster cells F, G, H are discharged such that all regions of the raster surfaces of the photoconductor layer associated with the raster cells F, G, H are discharged below the development threshold. Given subsequent development with toner, these raster cells are thus completely inked with toner, whereby a line width of three raster cells results.

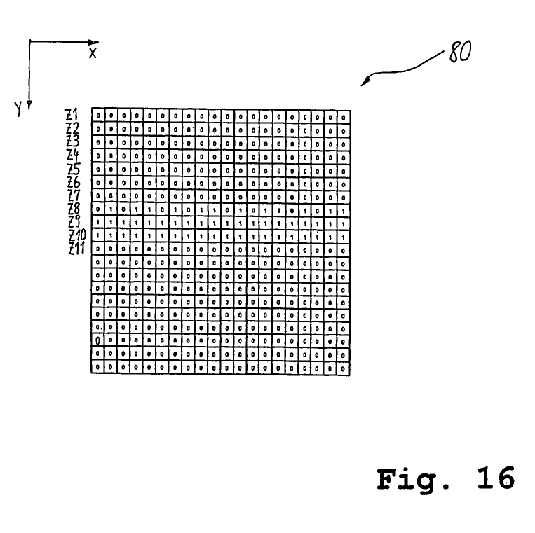

A matrix 80 with target print data is shown in FIG. 16, whereby the cells of the matrix 80 correspond to raster cells of a target image. The matrix 80 coincides with the matrix 34 according to FIG. 11, whereby, however, the print data contained in the matrix 80 only have a word length of 1 bit. With the aid of the target print data, the light sources are activated only with the aid of two signal states such that they emit a predetermined light quantity on the associated raster surface of the photoconductor layer upon logical signal state 1 and emit no light on the associated raster surface given logical signal state 0.

The target image data of the matrix 80 have been generated from the source image data according to FIG. 10 with the method known from International Patent Publication No. WO 98/43207. The target image data according to FIG. 16 have likewise been generated with a Boolean combinatorial circuit 30. The target image data of the rows Z9 and Z10 have the signal state 1, whereby the target image elements of the target image are to be represented as black areas. The target image data of the target image elements of the row Z8 alternately (corresponding to a preset scheme) contain the signal states 0 and 1, whereby a plurality of identical signal states can also follow in succession. The total area of the surface inked by the target image elements of the row Z8 approximately corresponds to half of the area of all raster cells of the row Z8.

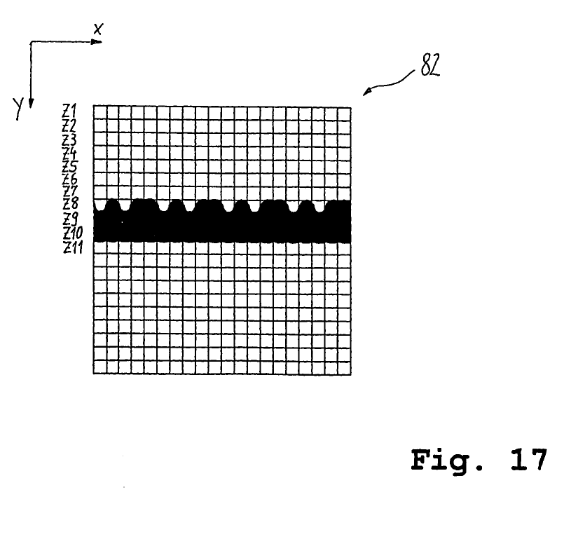

A strongly magnified target print image 82 that has been generated with the aid of the print data according to FIG. 16 is shown in FIG. 17. The area inked by the target image elements of the target print image 82 approximately corresponds to the area inked by the source image elements according to FIG. 10. Approximately the same line is thereby represented in the target print image 82 as in the source print image 10. In a conversion of the source image 32, the known method to generate a print image according to FIGS. 16 and 17 leads to a target image 82, whereby a target print image 82 that optically does not exactly coincide with the source print image 32 is generated. However, via the inventive method specified in connection with FIGS. 11 through 15, a target print image 36 is generated that optically coincides exactly with the source print image 32. Print images that have been generated for printing systems with a resolution of 240 dpi or 400 dpi can thereby also be exactly reproduced with a printing system with a resolution of, for example, 600 dpi.

Via the inventive method, nearly arbitrarily wide lines can be generated, as specified in connection with FIGS. 13 through 15. Given system-dependent different reproductions of horizontal and vertical lines, the line width can be simply adapted to a uniform line width with the inventive method. The line widths of different printing systems can also be adjusted to one another with the aid of the inventive method such that all printing systems generate identical print images given identical print data.

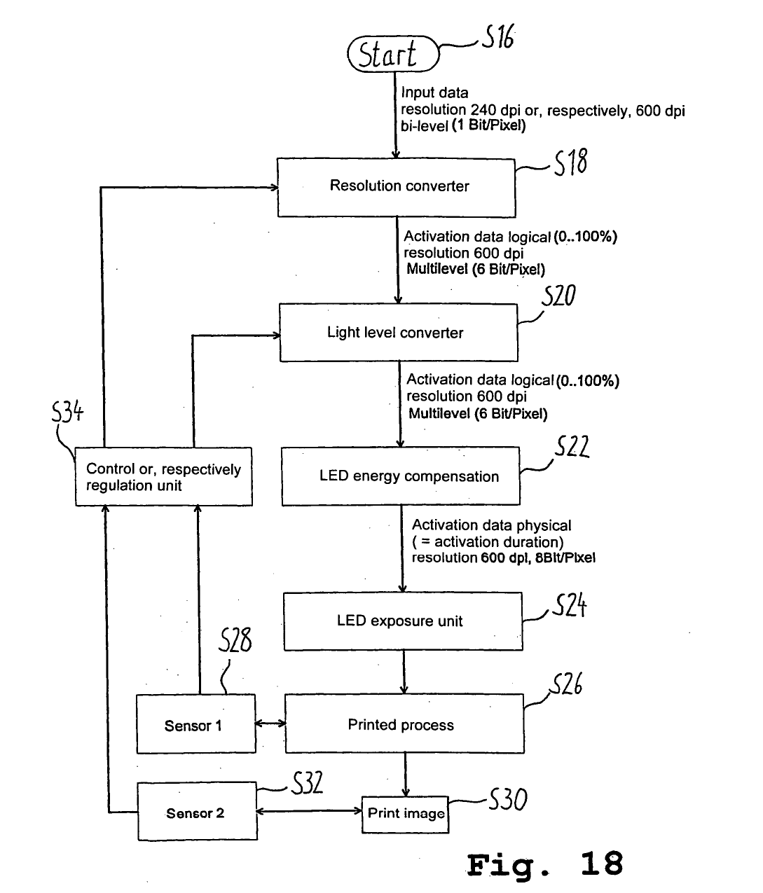

In FIG. 18, a flowchart for regulation of the line width of a printing system is shown. The process for regulation of the line width begins in step S16. In addition to the regulation of the line width, the source print data for generation of a source print image with a resolution of 240 dpi are transformed into target print data of a target print image with a resolution of 600 dpi in step S18. For this, the already described inventive method is used for conversion of source print data into target print data. The source print data have (as specified) a word length of 1 bit, whereby the target print data have a word length of 6 bits for each target image element. Activation data to activate the character generator or the light source are subsequently generated in step S20 from the target print data. If, for example, the target print data contain a value according to which the area of a target image element should be half-inked with toner, as already specified in connection with FIG. 11, the light source of the printing system in the exemplary embodiment must thus emit 0.7 times the light quantity of the light quantity that is necessary for complete inking of the raster surface of the target image element.

The activation data are then supplied to an activation unit for activation of the light source. In step S22, the activation time for each light source is subsequently determined from the activation data. In step S22, data that have a word length of 8 bits per target image element are thereby generated for each target image element corresponding to the determined activation time. With the aid of the determined activation time, the LED exposure time of the character generator is activated in step S24. Raster surfaces of the photoconductor layer belonging to the target image elements are exposed with the aid of the light quantity emitted by the LED exposure unit. Such an LED exposure unit can, for example, simultaneously expose all raster cells of a row.

In step S26, the regions of the photoconductor layer discharged via the LED exposure unit are inked with toner. The line width of lines generated on the photoconductor layer is detected with the aid of a first sensor arrangement in step S28, whereby the value of the determined line width is supplied to a control and regulation unit. The print image generated on the photoconductor layer in step S26 is transfer printed and fixed onto a carrier material in step S30.

With the aid of a second sensor arrangement, the line width of at least one line of the print image is detected in step S32, whereby the value of the line width is supplied to the control and/or regulation unit. In step S34, at least one correction value is generated with the aid of the control and/or regulation unit corresponding to the values of the determined line width of the first and/or second sensor arrangement. This correction value is used upon conversion of subsequent source print data of the source print images into target print data of the target print images in step S18. Simultaneously or alternatively, the correction value can also be used in conversion of the target print data into activation data in step S20.

The regulation described with the aid of the flow plan according to FIG. 18 can also be used for regulation of the line width of print images whose print data already exists for generation of print images with a resolution of 600 dpi. The step S18 for conversion of the source image data into target image data is then omitted. The correction of the line width then ensues only in step S20. Nearly arbitrary line widths can be generated via the inventive method. The exemplary embodiments specified in connection with FIGS. 1 through 18 refer to a printing system in which surfaces to be inked are discharged.

The light distribution curve of the light source does not correspond to a Gaussian curve in other exemplary embodiments, for example, due to different optics. The discharge curves 54, 56, 58, 66, 72, 60, 68, 74 in this case have a curve deviating from the graphs according to FIG. 13 through 15, which, however, has no influence on the inventive method. The light quantity supplied to the raster cells must, if applicable, be adapted in these exemplary embodiments. The inventive method is also not limited to source print data with a resolution of 240 dpi and 400 dpi, nor is it limited to target print data with a resolution of 600 dpi. Rather, with the aid of the inventive method, target print data with an arbitrary second resolution can be generated from source print data of source print images with an arbitrary first resolution.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### REFERENCE LIST

10, 10a source print image
12 partial source print image
A, B, C, D source image elements
X, Y coordinates
a1 through e5 target image elements
14 target image
16 partial target image
20 Boolean combinatorial circuit
22, 22a source image
24 partial source image
26 target image
28 partial target image
30 Boolean combinatorial circuit
32 source image
34 target image matrix
Z1 through Z10 rows
36 target image
38 inked surface
40 intersection line
42 through 52 boundary lines
54, 56, 58, 66, 72 discharge curves
60, 68, 74 sum discharge curves
62 development threshold
S10 through S34 process steps
Z charge

1-26. (canceled)

27. A method to generate a print image, comprising:
associating image elements of a line of a print image to be generated with matrix-shaped raster cells;
establishing a width of the line utilizing at least one first image element and a second image element of adjoining raster cells;
changing a charge of a raster surface of a conductive layer associated with the respective image element based on corresponding data associated with each image element;
providing a charge modification, corresponding to a charge distribution curve, in at least sub-regions of adjacent raster cells abutting the raster surface;
supplying a first charge quantity to a first raster surface associated with the first image element, the first charge quantity discharging the first raster surface below a development threshold or charging the first raster surface such that the charge of the first raster surface is above the development threshold;
supplying a second charge quantity smaller relative to the first charge quantity to a second raster surface associated with the second image element, such that a sub-region of the second raster surface abutting the first raster surface is discharged below the development threshold via the second charge quantity and via a portion of the first charge quantity that acts on the second raster surface or that, via the second charge quantity and via the portion of the first charge quantity that acts on the second raster surface, a sub-region of the second raster surface abutting the first raster surface is charged such that the charge of this sub-region is above the development threshold; and
establishing the width of the line to be generated at least by the first raster surface and the sub-region of the second raster surface abutting the first raster surface.

28. The method according to claim 27, further comprising:
electrically charging the conductive layer to a set first potential, the second charge quantity being smaller than the first charge quantity;
discharging the first charge quantity for the first raster surface below a second potential; and
discharging a region of the second raster surface abutting the first raster surface below the second potential via the second charge quantity and via the portion of the first charge quantity that impinges on the second raster surface.

29. The method according to claim 28, further comprising:
activating the charge modification in at least three levels, wherein the raster surface is not discharged to a preset potential in a first level, is partially discharged to a preset potential in a second level, and is nearly completely discharged to a preset potential in a third level.

30. The method according to claim 27, further comprising:
providing the conductive layer with a reference potential, the second charge quantity being smaller than the first charge quantity;
charging the first charge quantity of the first raster surface such that the charge of the region is above a second potential; and
charging a region of the second raster surface abutting the first raster surface via the second charge quantity and via the portion of the first charge quantity that impinges on the second raster surface such that the charge of the region is above the second potential.

31. The method according to claim 30, further comprising:
activating the charge modification in at least three stages, wherein the raster surface is not charged to a preset potential in a first level, is partially charged to a preset potential in a second level and is nearly completely charged to a preset potential in a third level.

32. The method according to claim 28, further comprising:
forming a development threshold by the second potential given development of the charge image of the conductive layer with toner.

33. The method according to claim 27, wherein the generated line is a boundary line of a region to be inked with toner, the method further comprising:
charging or discharging raster surfaces of image elements that are not to be inked with toner, the second image element being arranged on an outer edge of the region not to be inked.

34. The method according to claim 27, wherein the generated line is a boundary line of a region to be inked with toner, the method further comprising:
charging or discharging raster surfaces of image elements that are to be inked with toner, the second image element being arranged on an outer edge of the region to be inked.

35. The method according to claim 27, wherein discharged regions comprise discharged raster surfaces and discharged parts of raster surfaces, and charged regions comprise charged raster surfaces and charged parts of raster surfaces.

36. The method according to claim 27, further comprising:
converting source image data of a source image whose source image elements with a predetermined first resolution are arranged corresponding to a source image raster into target image data of a target image whose target image elements with a second resolution that differ from the first resolution and differ by a conversion factor are arranged corresponding to a target image raster.

37. The method according to claim 36, further comprising:
dividing the source image into matrix-shaped partial images; and
determining, for each partial source image, an associated partial target image from the source image data according to calculation operations identical for all partial images, the partial target image being arranged at a position in the target image that coincides with a position of the associated partial source image in the source image.

38. The method according to claim 36, wherein the generation of the target image data ensues with the aid of the source image data for target image elements whose raster surface region in the source image contains partial regions of at least two source image elements corresponding to the source image data and the surface proportions of the source image elements at the target image element.

39. The method according to claim 37, wherein every partial source image contains four source image elements.

40. The method according to claim 38, wherein every partial source image contains four source image elements.

41. The method according to claim 36, wherein the conversion factor is 1.5, the first resolution is 400 dpi, and the second resolution is 600 dpi.

42. The method according to claim 36, wherein the conversion factor is 2.5, the first resolution is 240 dpi, and the second resolution is 600 dpi.

43. The method according to claim 36, wherein the source image data of a source image element have a word length of one bit, the method further comprising:
generating the target image data of a target image element with a word length of at least two bits.

44. The method according to claim 36, further comprising:
utilizing, for the conversion of the source image data into target image data, at least one of hard-wired logic and a program module whose commands are executed by a data processing system.

45. The method according to claim 27, further comprising:
controlling the charge modification in 64 levels, wherein a different charge quantity is emitted onto raster surfaces at each level.

46. The method according to claim 27, further comprising:
controlling charge quantity by at least one of intensity and activation duration of a light source, the conductive layer comprising a photoconductor layer.

47. The method according to claim 27, further comprising:
changing the line width of a line contained in a print image via a formation of differently-sized charged and discharged regions on the conductive layer.

48. The method according to claim 47, further comprising:
determining the line width of printed lines via a sensor arrangement;
implementing a comparison of the determined line width with a predetermined line width; and
adapting charged and discharged regions of subsequent print images corresponding to the comparison result.

49. The method according to claim 47, further comprising:
detecting a line width of at least one of lines running in a conveying direction of the carrier material, lines running transverse to the conveying direction, and of lines running at an angle to the conveying direction; and
adapting the line width of lines to be printed subsequently such that lines are generated with a uniform line width.

50. The method according to claim 27, further comprising:
activating light sources of a character generator.

51. A printing system configured to generate a print image, comprising:
a conductive layer having a raster surface;
matrix-shaped raster cells with which are associated image elements via which a line of a print image is generated, at least one first image element and a second image element of adjoining raster cells establishing a width of the line;
a charge supply mechanism via which a charge quantity can be supplied to an image element corresponding to data associated with each image element, via which charge quantity a charge of the raster surface of the conductive layer associated with a respective image element is changed, a the charge modification on the conductive layer ensuing corresponding to a charge distribution curve, and a portion of the charge quantity ensuing for at least one of regions of adjacent raster surfaces abutting the raster surface;
wherein
a first charge quantity can be supplied to a first raster surface associated with the first image element, the first charge quantity discharging the first raster surface below a development threshold or charging the first raster surface such that the charge of the first raster surface is above the development threshold;
a second charge quantity, smaller relative to the first charge quantity, can be supplied to the second raster surface associated with the second image element, such that a sub-region of the second raster surface abutting the first raster surface is discharged below the development threshold via the second charge quantity and via a portion of the first charge quantity that impinges on the second raster surface or that, via the second charge quantity and via a portion of the first charge quantity that acts on the second raster surface, a sub-region of the second raster surface abutting the first raster surface is charged such that the charge of this sub-region is above the development threshold, the width of the line to be generated being established at least by the first raster surface and the sub-region of the second raster surface abutting the first raster surface.

52. A data processing system to convert print data, comprising:
a charging mechanism configured to charge a conductive layer;
a computer configured to convert source image data of a source image whose source image elements with a predetermined first resolution are arranged corresponding to a first source image raster into target image data of a target image whose target image elements with a second resolution different from the first resolution by a conversion factor are arranged corresponding to a target image raster, the source image data having a word length of one bit;
at least one first target image element and a second target image element adjacent to the first target image element establishing a width of a line to be generated;
the computer being configured to generate target image data with a word length of at least two bits, wherein, with these target image data, a charge modification of a conductive layer can be controlled with the charging mechanism.

53. A method to generate a print image, comprising:
generating a print image that image elements that are associated with matrix-shaped raster cells;
establishing a width of a line of the print image from at least one first image element and a second image element of adjoining raster cells;
changing a charge of a raster surface of a light-sensitive photoconductor layer associated with the respective image element based on corresponding data associated with each image element via a light quantity emitted with the aid of at least one light source;
emitting, by the light source, a portion of the light quantity at least on sub-regions of adjacent raster cells abutting the raster surface, corresponding to its light distribution curve;
supplying a first light quantity to a first raster surface associated with the first image element, the first light quantity discharging the first raster surface below a development threshold or charging the first raster surface such that the charge of the first raster surface is above the development threshold;
supplying a second light quantity smaller relative to the first light quantity to a second raster surface associated with the second image element, such that a sub-region of the second raster surface abutting the first raster surface is discharged below the development threshold via the second light quantity and via the portion of the first light quantity that impinges on the second raster surface or that, via the second light quantity and via the portion of the first light quantity that impinges on the second raster surface, a sub-region of the second raster surface abutting the first raster surface is charged such that the charge of this sub-region is above the development threshold; and
establishing the width of the line to be generated at least by the first raster surface and the sub-region of the second raster surface abutting the first raster surface.

54. A printing system to generate a print image, comprising:
a light sensitive photoconductive layer having a raster surface;
matrix-shaped raster cells with which are associated image elements via which a line of a print image is generated, at least one first image element and a second image element of adjoining raster cells establishing a width of the line;
a light source via which a charge of the raster surface of the light-sensitive photoconductor layer associated with the respective image element is changed with, the light source configured to emit a light quantity corresponding to data associated with each image element, the light source further being configured to emit a portion of the light quantity at least on sub-regions of adjacent raster surfaces abutting the raster surface corresponding to its light distribution curve;
the light source being configured to supply a first light quantity to the first raster surface associated with the first image element, the first light quantity discharging a first raster surface below a development threshold or charging the first raster surface such that the charge of the first raster surface is above the development threshold;
the light source being further configured to supply a second light quantity smaller relative to the first light quantity to a second raster surface associated with the second image element such that a sub-region of the second raster surface abutting the first raster surface is discharged below the development threshold via the second light quantity and via the portion of the first light quantity that impinges on the second raster surface or that, via the second light quantity and via the portion of the first light quantity that impinges on the second raster surface, a sub-region of the second raster surface abutting the first raster surface is charged such that the charge of this sub-region is above the development threshold;
the width of the line to be generated being established at least by the first raster surface and the region of the second raster surface abutting the first raster surface.

55. A data processing system configured to convert print data, comprising:
a light source configured to expose a photoconductive layer;
a computer configured to convert source image data of a source image whose source image elements with a predetermined first resolution are arranged corresponding to a first source image raster into target image data of a target image whose target image elements with a second resolution different from the first resolution by a conversion factor are arranged corresponding to a target image raster, the source image data having a word length of one bit;
at least one first target image element and a second target image element adjacent to the first target image element establishing a width of a line to be generated;
the computer being configured to generate target image data with a word length of at least two bits, wherein, with these target image data, the light source can be activated for exposure of a photoconductor layer.
